(19) United States
(12) Patent Application Publication
(10) Pub. No.: US 2021/0312231 A1
(43) Pub. Date: Oct. 7, 2021

(54) NEURAL NETWORK DEVICE

(71) Applicant: SONY CORPORATION, Tokyo (JP)

(72) Inventors: Yuji TOKOZUME, Tokyo (JP); Toru CHINEN, Tokyo (JP); Yuki YAMAMOTO, Tokyo (JP)

(21) Appl. No.: 17/250,777

(22) PCT Filed: Aug. 28, 2019
(86) PCT No.: PCT/JP2019/033625

§ 371 Date: Mar. 3, 2021

(30) Foreign Application Priority Data
Sep. 11, 2018 (JP) 2018-169718

(51) Int. Cl. G06K 9/62; G06F 3/16; G06N 3/04

(52) U.S. Cl. CPC G06K 9/6256; G06N 3/0481; G06F 3/16

(57) ABSTRACT

The present technology relates to a neural network device capable of improving recognition performance. The neural network device includes a non-linear transformation layer processing unit that performs a transformation with a non-linear function having a learnable parameter. The present technology can be applied to a neural network.

### TECHNICAL FIELD

The present technology relates to a neural network device, and more particularly to a neural network device capable of improving recognition performance.

### BACKGROUND ART

For example, a technology for automatically recognizing (identifying, detecting, or the like) a variety of signals such as image signals and audio signals is considered. Here, it is assumed that a neural network is considered as a method for recognition (see, for example, Non-Patent Document 1).

A neural network processing device that takes a certain signal as an input and outputs a result of recognition processing for that signal has a configuration in which, for example, a convolution layer processing unit, an activation layer processing unit, a pooling layer processing unit, a convolution layer processing unit, an activation layer processing unit, a pooling layer processing unit, a convolution layer processing unit, and an activation layer processing unit are arranged in order from the input side to the output side.

Such a neural network processing device takes data of a certain signal as an input, transforms data with the eight components starting from the first convolution layer processing unit and ending with the last activation layer processing unit, and outputs a recognition result for the input data.

In general, it is said that the larger the scale of the neural network (the number of components and the number of coefficients), the more complicated the input/output relationship can be realized.

### CITATION LIST

### Non-Patent Document

Non-Patent Document 1: Ian Goodfellow, Yoshua Bengio, and Aaron Courville, Deep Learning, The MIT Press, 2016

### SUMMARY OF THE INVENTION

### Problems to be Solved by the Invention

However, signals input to a neural network vary in magnitude in some cases.

For example, using a neural network to identify an environmental sound in an office from a variety of environmental sounds is considered.

While an extremely large signal such as an environmental sound in a train or an aircraft may be input to this neural network, a signal of an environmental sound in an office to be identified is small in most cases.

In order to accurately identify an environmental sound in an office, it is necessary to analyze small signals in more detail. In order to obtain high recognition performance as described above, it is necessary to construct a neural network and perform learning of the neural network to enable dealing with input signals that vary in magnitude.

In addition, in a case where a neural network is used to detect signals input to a microphone, due to the microphone being used as a user interface (the microphone is tapped, blocked, or the like), the input signals vary in magnitude.

For example, when the microphone is tapped, a signal that is extremely larger than other environmental sounds is input to the microphone. Furthermore, when the microphone is blocked, a signal that is extremely smaller than other environmental sounds is input to the microphone. Even in a case where these signals are detected individually or simultaneously, it is required to construct a neural network and perform learning of the neural network so as to enable dealing with input signals that vary in magnitude.

However, at present, there is no neural network having components capable of dealing with input signals that vary in magnitude. Furthermore, in order to deal with input signals that vary in magnitude, it is necessary to increase the scale of the neural network so that a complicated input/output relationship can be realized, and it is difficult to obtain high performance in a case where the scale of the neural network is limited due to a hardware restriction or the like.

The present technology has been made in view of such a situation, and makes it possible to improve the recognition performance.

### Solutions to Problems

A neural network device according to one aspect of the present technology includes a non-linear transformation layer processing unit that performs a transformation with a non-linear function having a learnable parameter.

According to the one aspect of the present technology, a transformation is performed by the non-linear transformation layer processing unit that performs the transformation with the non-linear function having the learnable parameter

### BRIEF DESCRIPTION OF DRAWINGS

FIG. 1 is a diagram illustrating a configuration example of a neural network processing device.

FIG. 2 is a flowchart illustrating recognition processing.

FIG. 3 is a diagram illustrating a configuration example of a neural network learning device.

FIG. 4 is a flowchart illustrating learning processing.

FIG. 5 illustrates a formula and a graph representing a relationship between an input and an output of a logarithmic layer.

FIG. 6 is a diagram illustrating an operation by a user.

FIG. 7 is a diagram illustrating a detection success rate of each operation.

FIG. 8 is a diagram illustrating a formula and a graph representing a relationship between an input and an output of an inverse proportional layer.

FIG. 9 is a diagram illustrating a formula and a graph representing a relationship between an input and an output of a power layer.

FIG. 10 is a diagram illustrating a configuration example of a computer.

### MODE FOR CARRYING OUT THE INVENTION

An embodiment to which the present technology is applied will be described below with reference to the drawings.

### First Embodiment

### Configuration Example of Neural Network Processing Device

The present technology allows for an improvement in recognition performance by constructing a neural network having a non-linear transformation with a learnable parameter as a component. That is, even in a case where the scale of the neural network is limited, high performance can be obtained.

Note that the non-linear transformation described above may be performed by, for example, using at least one of a logarithmic function, a power function, an exponential function, a trigonometric function, a hyperbolic function, or another linear or non-linear function, and a function obtained by using four arithmetic operations, composition, or the like on them.

The neural network of the present technology is designed to have components capable of dealing with input signals that vary in magnitude. This neural network has a non-linear transformation with a learnable parameter as a component.

Such a non-linear transformation component performs an optimum scale transformation for input signals that vary in magnitude, so that the neural network can analyze in more detail a portion where the magnitudes of the input signals are concentrated.

As a result, even a small-scale neural network can deal with input signals that vary in magnitude, and high recognition performance can be obtained.

Features of a neural network to which the present technology is applied will be described below, and a neural network having a “logarithmic layer” as a component that performs a non-linear transformation using a logarithmic function will be described as an example of the neural network to which the present technology is applied.

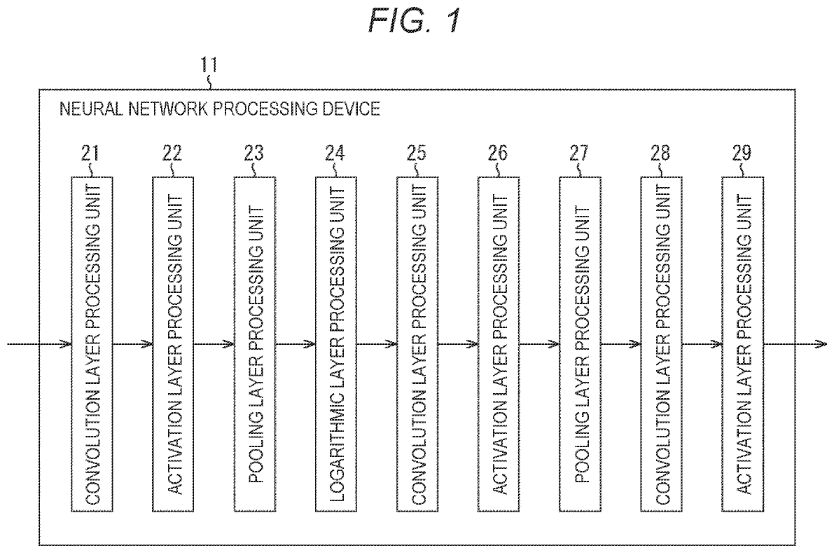

FIG. 1 is a diagram illustrating a configuration example of an embodiment of a neural network processing device to which the present technology is applied.

A neural network processing device 11 illustrated in FIG. 1 is constituted by a neural network, and includes a convolution layer processing unit 21, an activation layer processing unit 22, a pooling layer processing unit 23, a logarithmic layer processing unit 24, a convolution layer processing unit 25, an activation layer processing unit 26, a pooling layer processing unit 27, a convolution layer processing unit 28, and an activation layer processing unit 29.

In particular, the neural network processing device 11 is a neural network in which the logarithmic layer processing unit 24, that is, a logarithmic layer is introduced in addition to a general configuration.

The neural network processing device 11 performs processing of each layer (tier) of the neural network on input data, which is data that has been input, and outputs a recognition result regarding a predetermined recognition target for the input data. Here, the convolution layer processing unit 21 to the activation layer processing unit 29 are the layers of the neural network.

The convolution layer processing unit 21 performs convolution layer processing on the supplied input data, and supplies a result of the processing to the activation layer processing unit 22.

The activation layer processing unit 22 performs activation layer processing on the processing result supplied from the convolution layer processing unit 21, and supplies a result of the processing to the pooling layer processing unit 23.

The pooling layer processing unit 23 performs pooling layer processing on the processing result supplied from the activation layer processing unit 22, and supplies a result of the processing to the logarithmic layer processing unit 24.

The logarithmic layer processing unit 24 performs, as logarithmic layer processing, non-linear transformation processing using a logarithmic function on the processing result supplied from the pooling layer processing unit 23, and supplies a result of the processing to the convolution layer processing unit 25

The convolution layer processing unit 25 performs convolution layer processing on the processing result supplied from the logarithmic layer processing unit 24, and supplies a result of the processing to the activation layer processing unit 26.

The activation layer processing unit 26 performs activation layer processing on the processing result supplied from the convolution layer processing unit 25, and supplies a result of the processing to the pooling layer processing unit 27.

The pooling layer processing unit 27 performs pooling layer processing on the processing result supplied from the activation layer processing unit 26, and supplies a result of the processing to the convolution layer processing unit 28.

The convolution layer processing unit 28 performs convolution layer processing on the processing result supplied from the pooling layer processing unit 27, and supplies a result of the processing to the activation layer processing unit 29.

The activation layer processing unit 29 performs activation layer processing on the processing result supplied from the convolution layer processing unit 28, and outputs a result of the processing as a recognition result regarding a recognition target for the input data.

### Description of Recognition Processing

Next, operation of the neural network processing device 11 illustrated in FIG. 1 will be described.

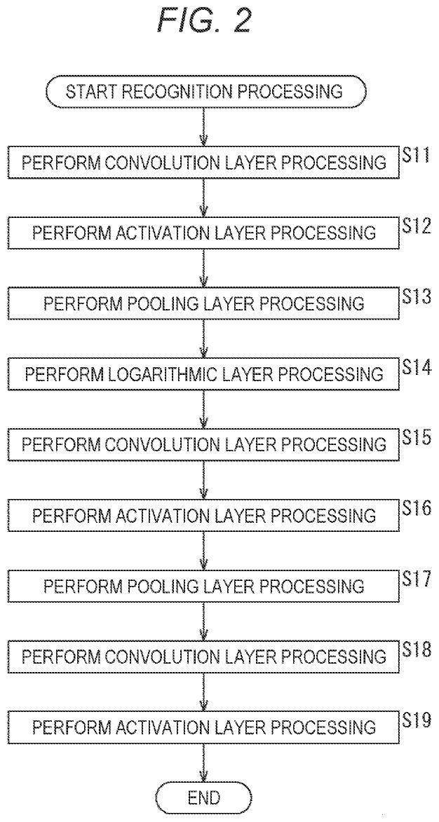

That is, recognition processing by the neural network processing device 11 will be described below with reference to a flowchart in FIG. 2.

In step S11, the convolution layer processing unit 21 performs convolution layer processing on supplied input data, and supplies a result of the processing to the activation layer processing unit 22.

In step S12, the activation layer processing unit 22 performs activation layer processing on the processing result supplied from the convolution layer processing unit 21, and supplies a result of the processing to the pooling layer processing unit 23.

In step S13, the pooling layer processing unit 23 performs pooling layer processing on the processing result supplied from the activation layer processing unit 22, and supplies a result of the processing to the logarithmic layer processing unit 24.

In step S14, the logarithmic layer processing unit 24 performs logarithmic layer processing on the processing result supplied from the pooling layer processing unit 23, and supplies a result of the processing to the convolution layer processing unit 25.

In step S15, the convolution layer processing unit 25 performs convolution layer processing on the processing result supplied from the logarithmic layer processing unit 24, and supplies a result of the processing to the activation layer processing unit 26.

In step S16, the activation layer processing unit 26 performs activation layer processing on the processing result supplied from the convolution layer processing unit 25, and supplies a result of the processing to the pooling layer processing unit 27.

In step S17, the pooling layer processing unit 27 performs pooling layer processing on the processing result supplied from the activation layer processing unit 26, and supplies a result of the processing to the convolution layer processing unit 28.

In step S18, the convolution layer processing unit 28 performs convolution layer processing on the processing result supplied from the pooling layer processing unit 27, and supplies a result of the processing to the activation layer processing unit 29.

In step S19, the activation layer processing unit 29 performs activation layer processing on the processing result supplied from the convolution layer processing unit 28, and outputs a result of the processing as a recognition result regarding a recognition target for the input data, and then the recognition processing ends.

As described above, the neural network processing device 11 performs the processing of transforming the data input in each layer of the neural network, and outputs a result of the processing as a recognition result regarding the recognition target. At this time, non-linear transformation processing is performed in at least one layer so that high recognition performance can be obtained even in a case of a small-scale neural network. That is, the recognition performance can be improved.

### Configuration Example of Neural Network Learning Device

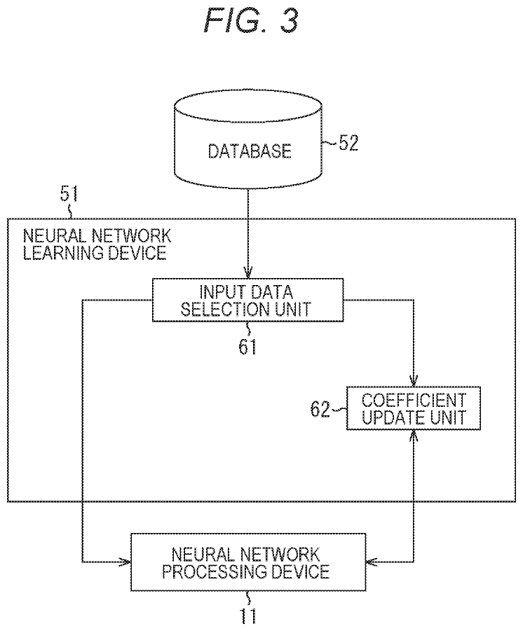

Furthermore, a neural network learning device that generates the neural network processing device 11 by learning has a configuration as illustrated in FIG. 3, for example. Note that, in FIG. 3, the same reference numerals are given to the portions corresponding to those in the case of FIG. 1, and the description thereof will be omitted as appropriate.

In the example illustrated in FIG. 3, a neural network learning device 51 generates (constructs) the neural network processing device 11 by learning on the basis of data of a signal input from a database 52.

The neural network learning device 51 includes an input data selection unit 61 and a coefficient update unit 62.

The input data selection unit 61 selects, from pieces of data of signals recorded in the database 52, data of a signal to be used for learning, and supplies the data to the coefficient update unit 62 and the neural network processing device 11.

In response to supply of data from the input data selection unit 61 and supply of a recognition result from the neural network processing device 11, the coefficient update unit 62 updates coefficients of a neural network, that is, coefficients (parameters) to be used for processing in the layers of the neural network processing device 11, and supplied the coefficients to the neural network processing device 11.

In FIG. 3, the neural network processing device 11, the neural network learning device 51, and the database 52 constitute a learning system for performing learning of the neural network processing device 11.

### Description of Learning Processing

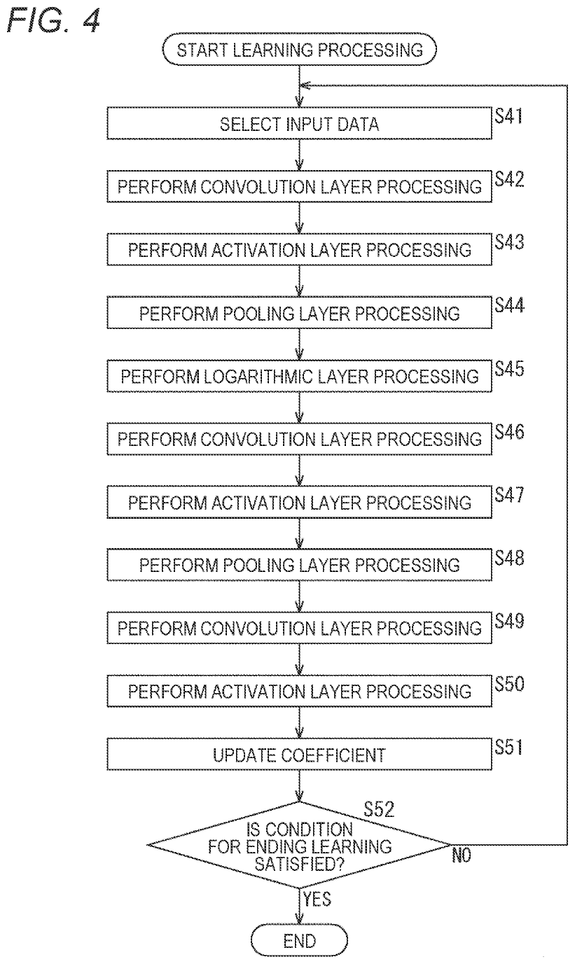

Next, learning processing performed by the learning system illustrated in FIG. 3 will be described. That is, the learning processing performed by the learning system will be described below with reference to a flowchart in FIG. 4.

In step S41, the input data selection unit 61 performs input data selection to select, from pieces of data of signals recorded in the database 52, input data to be used for learning, and supplies input data selected as a result of the selection to the coefficient update unit 62, and the convolution layer processing unit 21 of the neural network processing device 11.

When the input data is supplied to the convolution layer processing unit 21 of the neural network processing device 11 as described above, pieces of processing of step S42 to step S50 are performed. These pieces of processing are similar to those of step S11 to step S19 in FIG. 2, and the description thereof will be omitted.

That is, in step S42 to step S50, transformation processing (data transformation) is performed on the data by nine components (layers), from the convolution layer processing unit 21 on the leftmost side in FIG. 1, that is, on the input side, to the activation layer processing unit 29 on the rightmost side in FIG. 1, that is, on the output side, in the neural network processing device 11.

Then, data obtained by the processing in the activation layer processing unit 29 is supplied to the coefficient update unit 62 as a recognition result of a recognition target for the input data.

Note that, in the neural network processing device 11, the convolution layers and the logarithmic layer, that is, the convolution layer processing unit 21, the logarithmic layer processing unit 24, the convolution layer processing unit 25, and the convolution layer processing unit 28 use coefficients supplied from the coefficient update unit 62 to perform convolution layer processing and logarithmic layer processing, that is, processing of transforming data (transformation processing).

In step S51, the coefficient update unit 62 updates the coefficients on the basis of the input data supplied from the input data selection unit 61 and the recognition result supplied from the activation layer processing unit 29 of the neural network processing device 11.

In step S51, the coefficient update unit 62 updates the coefficients of the neural network so that the input data and the recognition result have a desired relationship, that is, a desired input/output relationship is realized. Here, coefficients used in the three convolution layers, that is, a coefficient used for the convolution layer processing in the convolution layer processing unit 21, the convolution layer processing unit 25, and the convolution layer processing unit 28, and a coefficient (parameter) used for the logarithm layer processing in the logarithmic layer processing unit 24 are updated. The coefficients may be updated by, for example, backpropagation.

When the coefficients are updated, the coefficient update unit 62 supplies the updated coefficients to each unit of the neural network processing device 11. The convolution layer processing unit 21, the logarithmic layer processing unit 24, the convolution layer processing unit 25, and the convolution layer processing unit 28 replace the coefficients that are held with the coefficients newly supplied from the coefficient update unit 62 to update the coefficients.

In step S52, the coefficient update unit 62 determines whether or not a condition for ending learning is satisfied.

For example, if the processing of step S41 to step S51 has been repeated a specified number of times, it is determined that the condition for ending learning is satisfied. Note that the condition for ending learning may be any condition such as an error between the desired input/output relationship and an actual input/output relationship being equal to or less than a threshold value.

If it is determined in step S52 that the condition for ending learning is not satisfied, the processing returns to step S41, and the processing described above is repeated.

On the other hand, if it is determined in step S52 that the condition for ending learning is satisfied, the learning processing ends.

In this case, the final neural network processing device 11 has been obtained by learning, the neural network processing device 11 is supplied from the coefficient update unit 62, and the coefficients that are finally held are used for recognition processing on the input data.

By using the neural network processing device 11 obtained by such learning, it is possible to output a correct recognition result even for unknown input data that is not included in the input data held in the database 52.

As described above, the learning system performs learning of the neural network processing device 11 by updating the coefficients used in the neural network processing device 11.

By learning and obtaining at least one coefficient including a coefficient of a layer that performs non-linear transformation processing such as a logarithmic layer, in particular, it is possible to obtain high recognition performance even in a case of a small-scale neural network. That is, the recognition performance of the neural network processing device 11 obtained by learning can be improved.

### Introduction of Logarithmic Layer

Here, the improvement of the recognition performance by introducing a logarithmic layer into the neural network will be described.

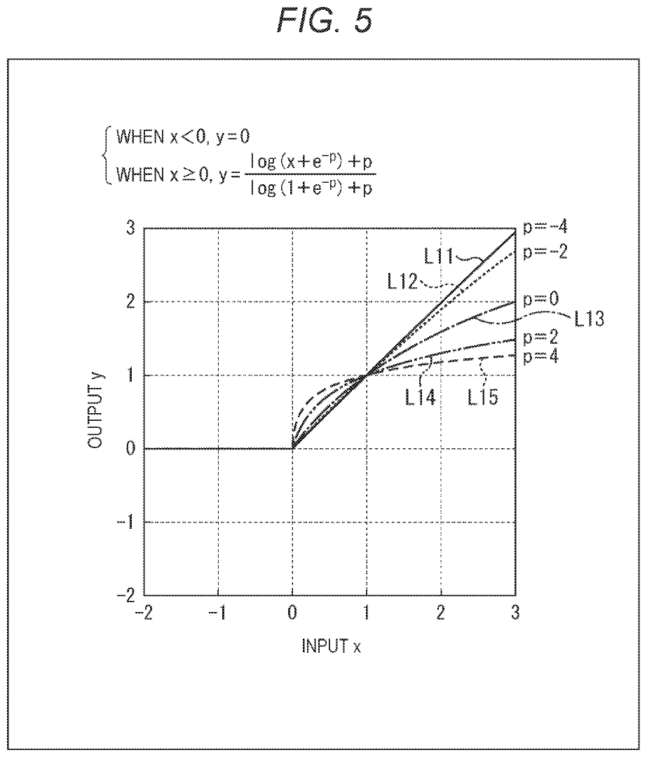

FIG. 5 illustrates a formula and a graph representing a relationship between an input and an output of a logarithmic layer (logarithmic layer processing unit 24). Note that, in FIG. 5, the horizontal axis represents an input x of the logarithmic layer, and the vertical axis represents an output y of the logarithmic layer.

In this example, when the input x is negative, that is, when x<0, the logarithmic layer (logarithmic layer processing unit 24) outputs 0 as the output y.

On the other hand, when the input x is positive, that is, when x≥0, the logarithmic layer (logarithmic layer processing unit 24) outputs, as the output y, a value of a function in which the larger the input x, the smaller the rate of change in the output y with respect to the input x.

Here, the output y is expressed by y=(log (x+e^{-P})+p)/(log (1+e^{-P})+p), where p is a predetermined coefficient (parameter). Note that, at the time of learning, this coefficient p is updated (learned) by the coefficient update unit 62.

In this example, the rate of change in the output y with respect to the input x is extremely large, particularly when the input x is positive and small. Furthermore, the coefficient (parameter) p is included, and changing this coefficient p changes the relationship between the input x and the output y as illustrated in FIG. 5.

In particular, here, a polygonal line L11 indicates a relationship between the input x and the output y when the coefficient p=−4, a curve L12 indicates a relationship between the input x and the output y when the coefficient p=−2, and a curve L13 indicates a relationship between the input x and the output y when the coefficient p=0.

In a similar manner, a curve L14 indicates a relationship between the input x and the output y when the coefficient p=2, and a curve L15 indicates a relationship between the input x and the output y when the coefficient p=4.

As described above, the larger the coefficient p, the larger the rate of change in the output y with respect to the input x when the input x is positive and small, and the curvature of the graph (curve) becomes larger. On the other hand, the smaller the coefficient p, the smaller the curvature of the graph, and the graph indicating the relationship between the input x and the output y becomes closer to a straight line in a range where the input x is positive. Moreover, the value of the coefficient p is learnable, and a shape of the graph more suitable for input signals (input data) that vary in magnitude can be automatically obtained by learning than in a case where the shape is determined by a human in some way.

In the logarithmic layer (logarithmic layer processing unit 24), the rate of change in the output y with respect to the input x when the input x is positive and small is large, and this allows the neural network having the logarithmic layer as a component, that is, the neural network processing device 11, to analyze in more detail small input signals (input data).

Thus, this neural network (neural network processing device 11) is particularly effective in a case where input signals (input data) vary in magnitude, such as in a case of identifying an environmental sound in an office or a sound of a microphone being blocked described above.

In order to accurately identify small input signals with large signals such as environmental sounds in a train or an aircraft also being input, it has been necessary to increase the scale of the neural network.

However, in the present technology, a logarithmic layer is introduced so that small input signals can be analyzed in more detail, and high identification performance (recognition performance) can be realized even in a case of a small-scale neural network.

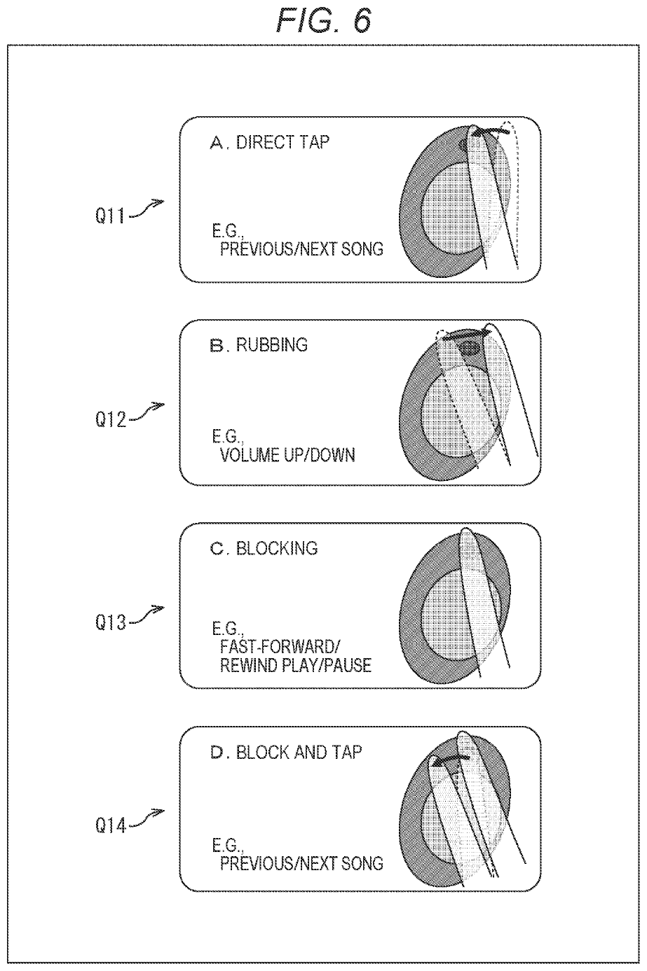

For example, as user interfaces that actually use a microphone, four types of user interfaces “direct tap”, “rubbing”, “blocking”, and “block and tap” as illustrated in FIG. 6 have been considered, and a signal input via the microphone by each of them has been detected with use of a neural network.

In FIG. 6, a portion indicated by an arrow Q11 indicates, as a user interface, that is, as an operation by a user, “direct tap”, which is an operation of a user directly tapping a microphone portion with a finger. Furthermore, a portion indicated by an arrow Q12 indicates, as a user interface, “rubbing”, which is an operation of a user rubbing the microphone portion with a finger.

A portion indicated by an arrow Q13 indicates, as a user interface, “blocking”, which is an operation of a user blocking the microphone portion with a finger. Moreover, a portion indicated by an arrow Q14 indicates, as a user interface, “block and tap”, which is an operation of a user blocking and tapping (tapping while blocking) the microphone portion with a finger.

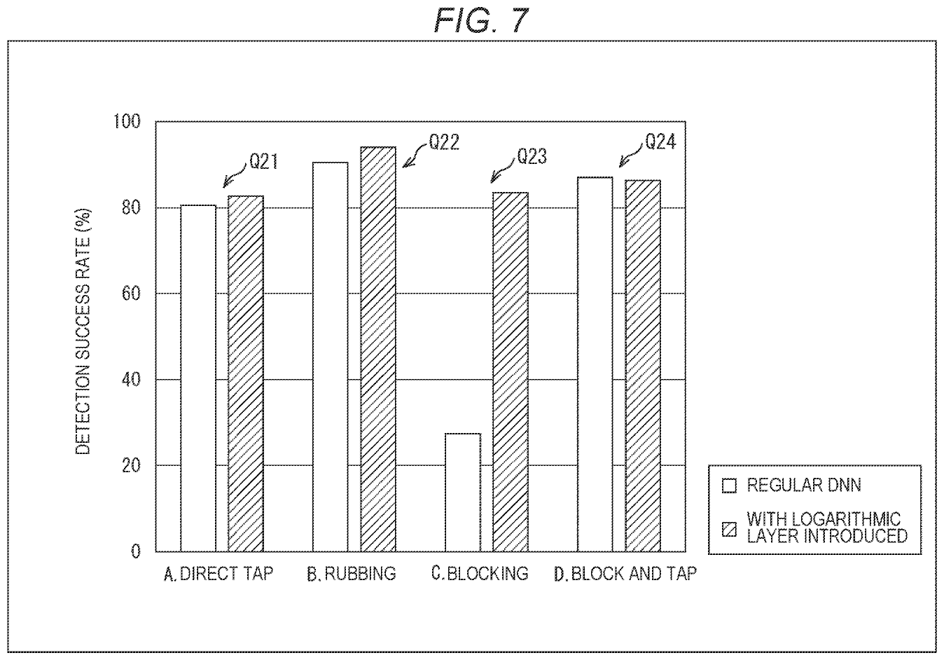

FIG. 7 illustrates, for such four types of operations, a result of recognition processing of recognizing each operation by a neural network using acoustic data obtained by collecting sound with the microphone as input data, that is, processing of recognizing sound generated when each operation is performed.

FIG. 7 illustrates, for the four types of operations, “direct tap”, “rubbing”, “blocking”, and “block and tap”, a detection success rate in a case where each operation is detected by using a general neural network (DNN) and a detection success rate in a case where each operation is detected by using the neural network processing device 11 in which a logarithmic layer is introduced. That is, in FIG. 7, the vertical axis indicates the detection success rate when each operation is detected (recognized).

In particular, in FIG. 7, a portion indicated by an arrow Q21 indicates the detection success rate of the operation “direct tap”, and a portion indicated by an arrow Q22 indicates the detection success rate of the operation “rubbing”. Furthermore, a portion indicated by an arrow Q23 indicates the detection success rate of the operation “blocking”, and a portion indicated by an arrow Q24 indicates the detection success rate of the operation “block and tap”.

Note that, in the portions indicated by the arrows Q21 to Q24, the left side in the drawing indicates the detection success rate in a case where a general neural network is used, and the right side in the drawing indicates the detection success rate in a case where the neural network processing device 11 is used.

Furthermore, FIG. 7 illustrates the detection success rate of the sound to be detected, that is, the operation to be recognized when a threshold value is set so that the excess detection rate is 0.01%.

In FIG. 7, it can be seen that the identification performance (recognition performance) is improved by the introduction of the logarithmic layer for three types of operations, “direct tap”, “rubbing”, and “blocking”. In particular, the identification performance is significantly improved for the operation “blocking”.

The value of the coefficient (parameter) p of the logarithmic layer learned for the operation “blocking” is 4.25, which is greater than the values of the coefficient p learned for the other three types of operations “direct tap”, “rubbing”, and “block and tap” (2.34, 1.29, and 1.06, respectively).

It means that the logarithmic layer has been learned so that smaller signals are analyzed in detail in order to detect the sound obtained when the operation “blocking”, which is a minute signal, is performed, that is, detect the operation “blocking”.

Moreover, an effective range of the logarithmic layer is not limited to cases of identifying an environmental sound in an office or a sound of the microphone being blocked, but is generally effective for audio signals in which the magnitude of a signal is often transformed to a logarithmic scale (decibel value or the like) or the like.

Furthermore, the present technology may be effective also for other signals such as images. Moreover, the present technology is similarly effective not only in small-scale neural networks but also in large-scale neural networks.

Note that the neural network described with reference to FIGS. 1 to 4 is an example of a neural network having components that perform non-linear transformation with learnable coefficients (parameters), and a variety of other modifications can be considered. First, as this component, a variety of examples other than the logarithmic layer can be considered.

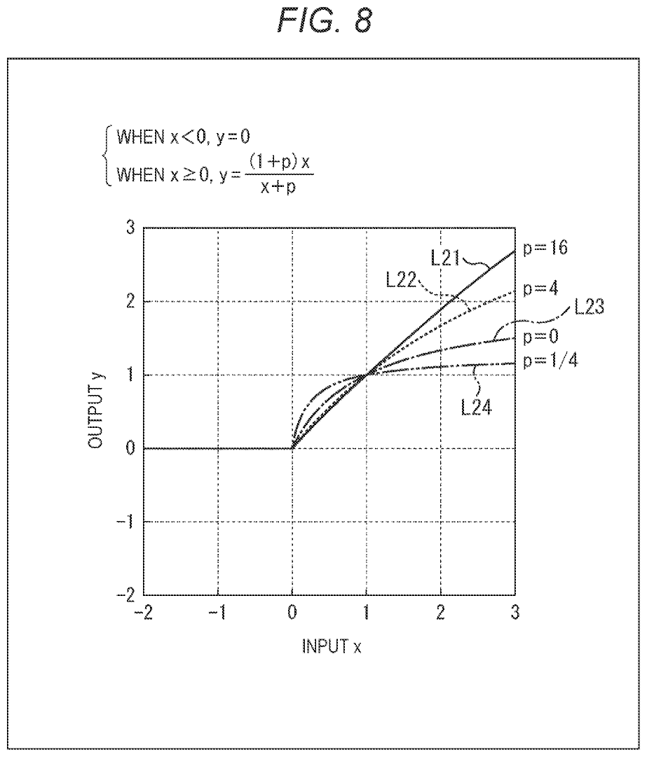

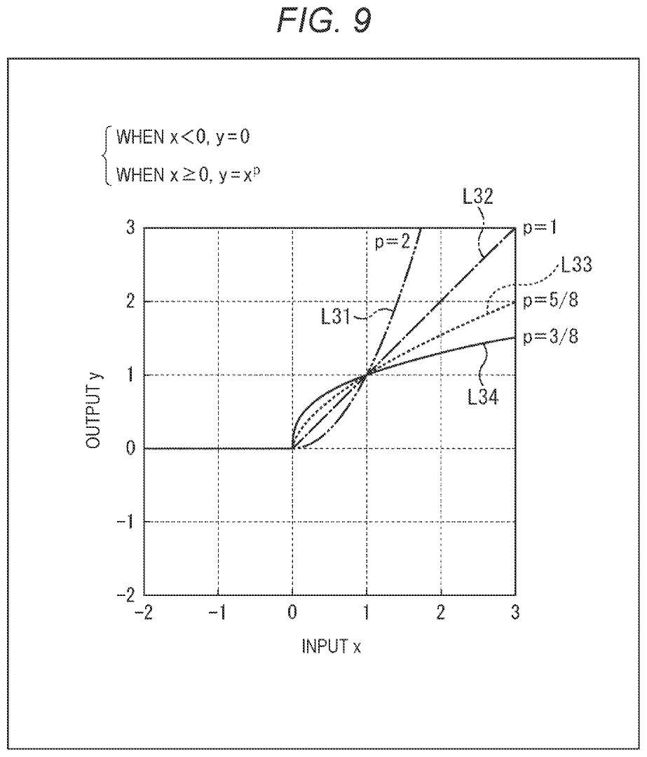

For example, for an inverse proportional layer using an inversely proportional function and a power layer using a power function as examples of components (layers) that perform non-linear transformation, formulas and graphs representing a relationship between an input and an output are illustrated in FIGS. 8 and 9. Note that, in FIGS. 8 and 9, the horizontal axis represents the input x and the vertical axis represents the output y.

FIG. 8 illustrates the relationship between the input x and the output y in the inverse proportional layer. When the input x is negative, that is, when x<0, the inverse proportional layer outputs 0 as the output y.

On the other hand, in the inverse proportional layer, when the input x is positive, that is, when x≥0, the output y is represented by y=(1+p) x/(x+p), where a coefficient (parameter) is expressed as p. Note that, at the time of learning, this coefficient p is updated (learned) by the coefficient update unit 62.

Furthermore, in FIG. 8, a polygonal line L21 indicates a relationship between the input x and the output y when the coefficient p=16, and a curve L22 indicates a relationship between the input x and the output y when the coefficient p=4. In a similar manner, a curve L23 indicates a relationship between the input x and the output y when the coefficient p=0, and a curve L24 indicates a relationship between the input x and the output y when the coefficient p=¼.

On the other hand, FIG. 9 illustrates the relationship between the input x and the output y in the power layer. When the input x is negative, that is, when x<0, the power layer outputs 0 as the output y.

On the other hand, in the power layer, when the input x is positive, that is, when x≥0, the output y is represented by y=x^{P}, where a coefficient (parameter) is expressed as p. Note that, at the time of learning, this coefficient p is updated (learned) by the coefficient update unit 62.

In FIG. 9, a curve L31 indicates a relationship between the input x and the output y when the coefficient p=2, and a polygonal line L32 indicates a relationship between the input x and the output y when the coefficient p=1. In a similar manner, a curve L33 indicates a relationship between the input x and the output y when the coefficient p=⅝, and a curve L34 indicates a relationship between the input x and the output y when the coefficient p=⅜.

In the inverse proportional layer illustrated in FIG. 8, in a similar manner to the logarithmic layer, the rate of change in the output y with respect to the input x becomes larger when the input x is positive and small.

Furthermore, in the power layer illustrated in FIG. 9, in a case where the coefficient p is smaller than 1, the rate of change in the output y with respect to the input x becomes larger when the input x is positive and small, while in a case where the coefficient p is larger than 1, the rate of change in the output y with respect to the input x becomes larger when the input x is positive and large. That is, large input signals can be analyzed in more detail.

In both the inverse proportional layer and the power layer, the relationship between the input x and the output y can be changed by changing the coefficient, that is, the parameter p, and moreover, the parameter is learnable. Furthermore, the non-linear transformation may be performed by using not only a logarithmic function or a power function (including an inversely proportional function), but also at least one of an exponential function, a trigonometric function, a hyperbolic function, or another linear or non-linear function, and a function obtained by using four arithmetic operations, composition, or the like on them. There may be two or more parameters (coefficients) for changing the relationship between the input x and the output y.

Furthermore, this component, that is, a component (layer) that performs a non-linear transformation can be introduced at any position in a neural network in any form.

For example, the component may be introduced as an activation function for the output of the convolution layer, or may be introduced for a coefficient of the convolution layer. Furthermore, this component may be introduced at a plurality of positions in a neural network.

Moreover, this component may have a coefficient (parameter) applied in common to all dimensions of the input x, or may have different coefficients applied, one for each dimension.

For example, in the example illustrated in FIG. 1, in a case where the number of filter types of the leftmost convolution layer (convolution layer processing unit 21) is 16, the logarithmic layer (logarithmic layer processing unit 24) has 16 types of input channels, and different parameters (coefficients) may be applied one for each of them.

Note that the parameters (coefficients) of this component may not be included in learning targets, and fixed values may be used. The fixed values may be determined by a human in some way. For example, the fixed values may be determined on the basis of a certain rule determined by a human from a statistical value of a distribution in magnitude of input signals or the like.

Moreover, an initial value at the time of learning of the parameters (coefficients) of this component may be determined on the basis of a value thus determined by a human. The parameters of this component and the coefficients of other components (convolution layers and the like) of the neural network may be learned at the same time, or one may be learned while the other is fixed.

According to the present technology as described above, the recognition performance of a neural network can be improved. Moreover, according to the present technology, high recognition performance can be obtained even with a small-scale neural network.

### Configuration Example of Computer

Meanwhile, the series of pieces of processing described above can be executed not only by hardware but also by software. In a case where the series of pieces of processing is executed by software, a program constituting the software is installed on a computer. Here, the computer includes a computer incorporated in dedicated hardware, or a general-purpose personal computer capable of executing various functions with various programs installed therein, for example.

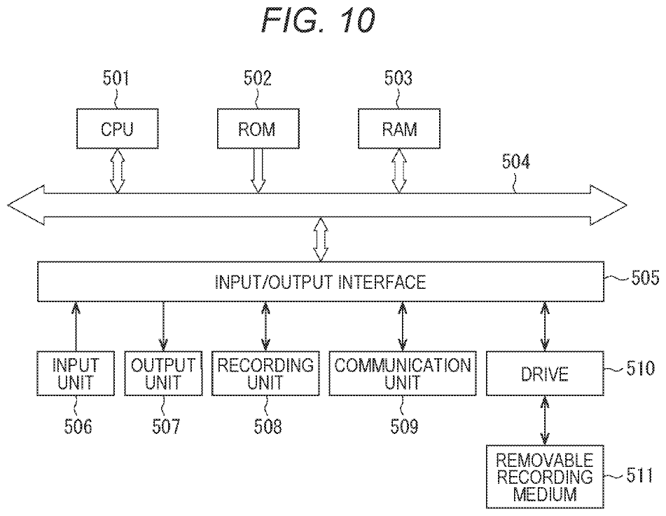

FIG. 10 is a block diagram illustrating a configuration example of hardware of a computer that executes the series of pieces of processing described above in accordance with a program.

In the computer, a central processing unit (CPU) 501, a read only memory (ROM) 502, and a random access memory (RAM) 503 are connected to each other by a bus 504.

The bus 504 is further connected with an input/output interface 505. The input/output interface 505 is connected with an input unit 506, an output unit 507, a recording unit 508, a communication unit 509, and a drive 510.

The input unit 506 includes a keyboard, a mouse, a microphone, an imaging element, or the like. The output unit 507 includes a display, a speaker, or the like. The recording unit 508 includes a hard disk, a non-volatile memory, or the like. The communication unit 509 includes a network interface or the like. The drive 510 drives a removable recording medium 511 such as a magnetic disk, an optical disk, a magneto-optical disk, or a semiconductor memory.

To perform the series of pieces of processing described above, the computer having a configuration as described above causes the CPU 501 to, for example, load a program recorded in the recording unit 508 into the RAM 503 via the input/output interface 505 and the bus 504 and then execute the program.

The program to be executed by the computer (CPU 501) can be provided by, for example, being recorded on the removable recording medium 511 as a package medium or the like. Furthermore, the program can be provided via a wired or wireless transmission medium such as a local area network, the Internet, or digital satellite broadcasting.

Inserting the removable recording medium 511 into the drive 510 allows the computer to install the program into the recording unit 508 via the input/output interface 505. Furthermore, the program can be received by the communication unit 509 via a wired or wireless transmission medium and installed into the recording unit 508. In addition, the program can be installed in advance in the ROM 502 or the recording unit 508.

Note that the program to be executed by the computer may be a program that performs the pieces of processing in chronological order as described in the present specification, or may be a program that performs the pieces of processing in parallel or when needed, for example, when the processing is called.

Furthermore, embodiments of the present technology are not limited to the embodiment described above but can be modified in various ways within a scope of the present technology.

For example, the present technology can have a cloud computing configuration in which a plurality of apparatuses shares one function and collaborates in processing via a network.

Furthermore, each step described in the flowcharts described above can be executed by one device or can be shared by a plurality of devices.

Moreover, in a case where a plurality of pieces of processing is included in one step, the plurality of pieces of processing included in that step can be executed by one device or can be shared by a plurality of devices.

Moreover, the present technology can also have the following configurations.

(1)

A neural network device including

a non-linear transformation layer processing unit that performs a transformation with a non-linear function having a learnable parameter.

(2)

The neural network device according to (1), in which the transformation with the non-linear function of the non-linear transformation layer processing unit is a transformation with a logarithmic function.

(3)

The neural network device according to (1), in which

the transformation with the non-linear function of the non-linear transformation layer processing unit is a transformation with a combination of a plurality of the non-linear functions.

(4)

The neural network device according to any one of (1) to (3), further including

an input unit to which input signals are input,

in which the input signals that vary in signal magnitude are input to the input unit.

(5)

The neural network device according to any one of (1) to (4), further including

a pooling layer processing unit,

in which processing by the non-linear transformation layer processing unit is performed after processing by the pooling layer processing unit.

(6)

The neural network device according to any one of (1) to (5), further including

a convolution layer processing unit,

in which processing by the non-linear transformation layer processing unit is performed before processing by the convolution layer processing unit.

(7)

The neural network device according to any one of (1) to (6), in which the transformation with the non-linear function of the non-linear transformation layer processing unit is performed as an activation function.

### REFERENCE SIGNS LIST

11 Neural network processing device

21 Convolution layer processing unit

24 Logarithmic layer processing unit

25 Convolution layer processing unit

28 Convolution layer processing unit

51 Neural network learning device

61 Input data selection unit

62 Coefficient update unit

1. A neural network device comprising
a non-linear transformation layer processing unit that performs a transformation with a non-linear function having a learnable parameter.

2. The neural network device according to claim 1, wherein the transformation with the non-linear function of the non-linear transformation layer processing unit is a transformation with a logarithmic function.

3. The neural network device according to claim 1, wherein
the transformation with the non-linear function of the non-linear transformation layer processing unit is a transformation with a combination of a plurality of the non-linear functions.

4. The neural network device according to claim 1, further comprising
an input unit to which input signals are input,
wherein the input signals that vary in signal magnitude are input to the input unit.

5. The neural network device according to claim 1, further comprising
a pooling layer processing unit,
wherein processing by the non-linear transformation layer processing unit is performed after processing by the pooling layer processing unit.

6. The neural network device according to claim 1, further comprising
a convolution layer processing unit,
wherein processing by the non-linear transformation layer processing unit is performed before processing by the convolution layer processing unit.

7. The neural network device according to claim 1, wherein the transformation with the non-linear function of the non-linear transformation layer processing unit is performed as an activation function.
